(19) United States
(12) Patent Application Publication
(10) Pub. No.: US 2015/0108922 A1
(43) Pub. Date: Apr. 23, 2015

(54) MOTOR DRIVING DEVICE FOR VEHICLE

(71) Applicants: Kia Motors Corporation, Seoul (KR); Hyundai Motor Company, Seoul (KR)

(72) Inventors: Jin Kim, Suwon (KR); Young Su Kim, Yongin (KR); Yong Wook Kwon, Seoul (KR); Ji Soo Park, Seoul (KR)

(73) Assignees: Kia Motors Corporation, Seoul (KR); Hyundai Motor Company, Seoul (KR)

(21) Appl. No.: 14/141,043

(22) Filed: Dec. 26, 2013

(30) Foreign Application Priority Data
Oct. 22, 2013 (KR) 10-2013-0125940

(51) Int. Cl. H02P 29/02; H02P 5/00

(52) U.S. Cl. CPC H02P 29/027; H02P 5/00
USPC 318/51; 318/461

(57) ABSTRACT

A motor driving device for a vehicle relates to a technology for preventing motor deterioration by controlling a stall current when a motor is controlled for vehicle air-conditioning. The motor driving device includes: a stall current detector that outputs a current detection signal by detecting a stall current of a motor, a controller that pre-stores a control specification of the motor, and outputs a control signal in response to the control specification when the current detection signal is activated; and an output driver that outputs a drive signal for controlling driving of the motor in response to the control signal.

### CROSS-REFERENCE TO RELATED APPLICATION

This application is based on and claims under 35 U.S.C. §119(a) priority from Korean patent application No. 10-2013-0125940 filed on Oct. 22, 2013, the disclosure of which is hereby incorporated in its entirety by reference, is claimed.

### BACKGROUND

(a) Field of the Invention

The present invention relates to a motor driving device for vehicles, and more particularly to a technology for preventing motor deterioration by controlling a stall current when a motor is controlled for vehicle air-conditioning.

(b) Description of the Related Art

Generally, an air-conditioner is mounted in a vehicle so as to properly maintain temperature, humidity, and air environment in response to a peripheral environment change, such that a pleasant environment can be provided for a driver and passenger of a vehicle.

Recently, air-conditioning systems of vehicles have become automated, such that temperature and airflow desired by a vehicle driver are established. An automatic temperature control device of the air-conditioning system automatically drives a blower in response to signals detected by various sensors or controls the speed of the blower, resulting in purification of indoor air of the vehicle.

A fan, a blower motor for driving the fan, and a blower-motor driver for driving the blower motor are mounted to an air-conditioner or heater of a vehicle, such that cool air and/or warm air can be supplied to the vehicle.

The above air-conditioning system can maintain temperature, humidity, purity, and airflow of indoor air of the vehicle in a comfortable or pleasant condition. Generally, the air-conditioning system is classified into an air-conditioner and a heater, and the air-conditioner or the heater is driven in response to a user-desired temperature. An intake door is driven according to selection of indoor or outdoor air of the vehicle, such that the outdoor air flows into an interior space of the vehicle or the indoor air flows into the air-conditioner, resulting in implementation of air circulation through the intake door.

When a user-desired temperature is established or when a heater or air-conditioner is driven by user manipulation, the air-conditioning system can enable a current temperature to reach a predetermined temperature by adjusting the opening degree of an Air Mix Door (AMD) disposed between an evaporator and a heater core.

Air being conditioned in a duct of the air-conditioning system in response to a predetermined temperature is transferred to an interior space of the vehicle through driving of the blower. In addition, a mode door is driven by a variety of mode functions such that the mode door is adjusted and controlled according to a wind direction (e.g., feet direction, front direction, or rear direction, etc.) or indoor-air or outdoor-air mode setting through activation of mode functions.

The above-mentioned functions are achieved by doors installed indoors and outdoors of the duct in such a manner that the opening or closing degree of an indoor or outdoor part of the duct is adjusted. Angles of such doors are adjusted in response to motor driving of an actuator. The door actuator for driving the aforementioned intake door may switch between an indoor-air mode and an outdoor-air mode, or may adjust the air temperature in response to a setting temperature, such that door angles can be adjusted in multiple stages.

For this purpose, a microcontroller for controlling an air-conditioner of a vehicle controls the actuator to rotate in a clockwise or counterclockwise direction, such that the opening degree of an air-mix door can be adjusted.

If a motor is driven by a motor driver as described above, several tens of mA may pass through the motor in a normal mode so that the motor is driven. However, if the motor stalls due to external force, several hundreds of mA are instantaneously supplied from the motor driver to the motor.

In this case, the motor and the motor driver are heated, such that it is impossible for chips of the motor driver to normally operate due to occurrence of thermal shutdown. In addition, assuming that the above stall phenomenon frequently occurs, lifespans of the chips of the motor driver and the motor are gradually reduced due to deterioration.

Specifically, a conventional multi-motor driver is unable to predict a surge stall current generated by external influence. Accordingly, the motor is driven on the basis of a maximum (Max) current. In this case, an overcurrent protection circuit is turned on, such that a semiconductor device unavoidably increases in size and cost.

### SUMMARY

Various embodiments of the present invention are directed to providing a motor driving device for a vehicle that substantially obviates one or more problems due to limitations and disadvantages of the related art.

An embodiment of the present invention relates to a technology for establishing a stall current value for each channel when a motor is controlled for vehicle air-conditioning, and preventing motor deterioration by driving a motor driver in response to the corresponding stall current.

In accordance with one aspect of the embodiment, a motor driving device for a vehicle includes: a stall current detector configured to output a current detection signal by detecting a stall current of a motor; a controller configured to pre-store a control specification of the motor, and output a control signal in response to the control specification when the current detection signal is activated; and an output driver configured to output a drive signal for controlling driving of the motor in response to the control signal.

In accordance with another aspect of the embodiment, a motor driving device for a vehicle includes: a plurality of stall current detectors configured to output a current detection signal by detecting a stall current of a plurality of motors; a plurality of controllers configured to pre-store control specifications of the plurality of motors, and output a control signal for selectively driving the plurality of motors in response to the control specification when the current detection signal is activated; and a plurality of output drivers configured to output a drive signal for selectively controlling the motors in response to the control signal.

### BRIEF DESCRIPTION OF THE DRAWINGS

FIG. 1 is a block diagram illustrating a motor driving device of a vehicle according to an embodiment.

FIG. 2 is a block diagram illustrating a motor driving device of a vehicle according to another embodiment.

FIGS. 3 to 6 are block diagrams illustrating coupling between a Printed Circuit Board (PCB) and the motor driving device for vehicles according to the embodiments.

### DETAILED DESCRIPTION

Reference will now be made in detail to the embodiments of the present invention, examples of which are illustrated in the accompanying drawings. Wherever possible, the same reference numbers will be used throughout the drawings to refer to the same or like parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the invention.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

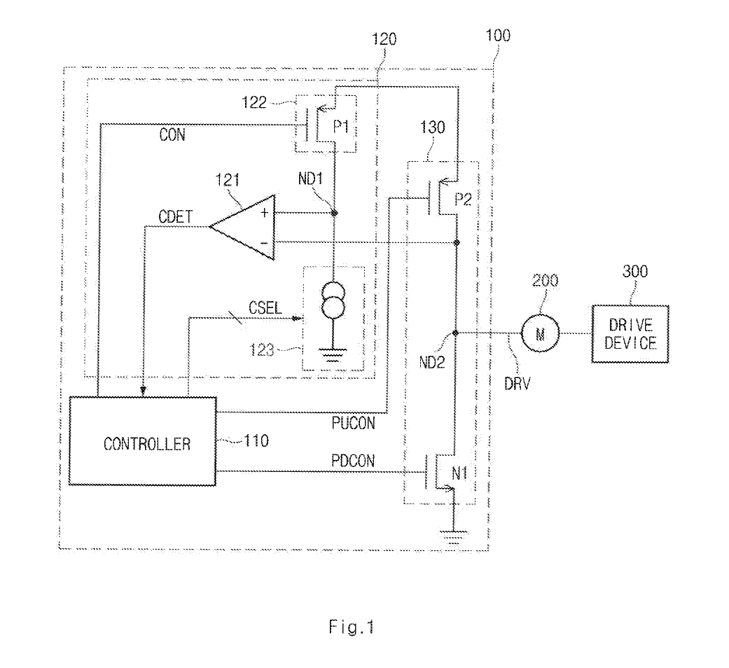

FIG. 1 is a block diagram illustrating a motor driving device of a vehicle according to an embodiment.

Referring to FIG. 1, the motor driving device for vehicles according to the embodiment includes a motor driver 100, a motor 200, and a drive device 300. In particular, the motor driver 100 may include a controller 110, a stall current detector 120, and an output driver 130. The stall current detector 120 may include a comparator 121, a current detector 122, and a current selector 123.

First, the motor driver 100 outputs a motor drive signal (DRV) to the motor 200 so as to control driving of the motor 200. For example, the motor 200 is driven upon receiving a high-level motor drive signal (DRV), and the motor stops operation upon receiving a low-level motor drive signal (DRV).

In addition, the operation state of the drive device 300 is controlled through driving of the motor 200. In particular, the drive device 300 may include a fan installed in an air-conditioner or heater of a vehicle, such that the fan is configured to serve as a means for mandatorily supplying cool air and/or warm air.

The air-conditioning system can maintain temperature, humidity, cleanliness, and airflow of indoor air of the vehicle in a comfortable or pleasant condition. A case of the air-conditioning system includes a passage for guiding air blown from a blower, and heat-exchangers for heating and cooling the blown air through the passage. Several doors are mounted to the air-conditioning system such that warm air or cool air heated or cooled through heat-exchangers can be distributed to respective parts of an interior space of the vehicle through the doors.

The drive device 300 according to the embodiment may include a door configured to blow cool air and/or warm air into the interior space of the vehicle.

The controller 110 may output a control signal (CON) for performing a current detection function to the current detector 122. If the current detection function needs to be performed, the controller 110 outputs a high-level control signal (CON). If the current detection function need not be performed, the controller 110 outputs a low-level control signal (CON).

The controller 110 may receive a current detection signal (CDET) from the comparator 121. If the current detection signal (CDET) received from the comparator 121 is at a high level, the controller 110 determines the occurrence of overcurrent. In this case, the controller 110 may output a high-level pull-up control signal (PUCON) and a high-level pull-down control signal (PDCON) such that the motor 200 stops operation.

In contrast, if the current detection signal (CDET) received from the comparator 121 is at a low level, the controller 110 determines the absence of overcurrent. In this case, the controller 110 outputs a low-level pull-up control signal (PUCON) and a low-level pull-down control signal (PDCON) such that the motor 200 starts to operate.

In addition, the controller 110 may establish a control condition of a current maximum stall current according to the detected current detection signal (CDET), a temperature condition, a voltage, a predetermined motor control specification, or the like. The controller 110 may generate a pull-up control signal (PUCON) and a pull-down control signal (PDCON) for controlling the output driver 130 in response to a control condition of the maximum stall current. For example, in order to drive the motor 200, the controller 110 may output a low-level pull-up control signal (PUCON) and a low-level pull-down control signal (PDCON). In order to stop the motor 200, the controller 110 may output a high-level pull-up control signal (PUCON) and a high-level pull-down control signal (PDCON).

The stall current detector 120 detects a current flowing from the motor driver 100 to the motor 200 so as to perform a protection function for preventing the motor driver 100 and the motor 200 from being deteriorated by overcurrent. In particular, assuming that the drive signal (DRV) supplied to the motor 200 is in an overcurrent state because the motor driver 100 or the motor is stalled, the stall current detector 120 detects the overcurrent state and stops the motor 200.

For this purpose, the comparator 121 compares an output signal of a node ND1 with an output signal of a node ND2, and thus outputs a current detection signal (CDET) to the controller 110. The comparator 121 receives a current of the node ND1 through a positive (+) terminal, and receives a current of the node ND2 through a negative (−) terminal.

The current detector 122 may control whether to perform the current detection function upon receiving the control signal (CON) from the controller 110. If the control signal (CON) received from the controller 110 is at a high level, the current detector 122 may perform the current detection function. If the control signal (CON) received from the controller 110 is at a low level, the current detector 122 may not perform the current detection function.

The current detector 122 includes a PMOS transistor P1. The PMOS transistor P1 is coupled between a source terminal of the PMOS transistor P2 and the node ND1 so that the PMOS transistor P1 receives the control signal (CON) through a gate terminal.

The current selector 123 is coupled between the node ND1 and a ground voltage terminal, so that the current selector 123 is controlled in response to a current selection signal (CSEL) received from the controller 110. A reference current value of the node ND1 may be adjusted by the current selector 123. In particular, the current selector 123 may be comprised of resistor(s). A resistance value of the current selector 123 is adjusted in response to the current selection signal (CSEL), such that the reference current flowing in the node ND1 can be adjusted by the current selector 123.

In addition, the output driver 130 is driven upon receiving the pull-up control signal (PUCON) and the pull-down control signal (PDCON) from the controller 110, such that it can control the drive signal (DRV) applied to the motor 200.

The output driver 130 may include a PMOS transistor P2 acting as a pull-up driving element and an NMOS transistor N1 acting as a pull-down driving element. The PMOS transistor P2 and the NMOS transistor N1 are coupled in series between a source terminal of the PMOS transistor P1 and a ground voltage terminal. The PMOS transistor P2 receives a pull-up control signal (PUCON) through a gate terminal. The NMOS transistor N1 receives the pull-down control signal (PDCON) through a gate terminal.

Various operations of the aforementioned motor driving device of a vehicle according to the embodiments will hereinafter be described with reference to the attached drawings. In the following description, the operations of the motor driving device will be described in different ways according to a first case in which overcurrent is detected and a second case in which overcurrent is not detected.

First, the first case in which overcurrent is detected in the motor driver 100 or the motor 200 will hereinafter be described in detail.

In accordance with the first case, the controller 110 outputs a high-level control signal (CON) when the current detection function is performed. If the control signal (CON) is at a high level, the PMOS transistor P1 of the current detector 122 is turned off. Accordingly, a current of the node ND1 may be adjusted by the current selector 120.

The controller 110 may establish a control condition of a current maximum stall current according to a detected current detection signal (CDET), a detected temperature condition, a voltage, a predetermined motor control specification, or the like. In response to the established control condition of the maximum stall current, the controller 110 may output a current selection signal (CSEL) to the current selector 123. The current selector 120 adjusts a resistance value upon receiving the current selection signal (CSEL) from the controller 110, such that the current selector 120 may establish a reference current value of the comparator 121.

The controller 110 may generate a pull-up control signal (PUCON) and a pull-down control signal (PDCON) for controlling the output driver 130 in response to the established control condition of the maximum stall current.

If the motor 200 is driven, the controller 110 may output a low-level pull-up control signal (PUCON) and a low-level pull-down control signal (PDCON), such that the PMOS transistor P2 is turned on and the NMOS transistor N1 is turned off. Accordingly, a high-level drive signal (DRV) is output to the motor 200 so that the motor 200 starts to operate.

Under this situation, the stall current detector may detect an overcurrent flowing in the motor 200. For this purpose, if a current of the node ND1 is higher than a current of the node ND2, the comparator 121 outputs a high-level current detection signal (CDET) such that specific information indicating occurrence of the stall current is transferred to the controller 110.

The controller 110 may control states of the pull-up drive signal (PUCON) and the pull-down drive signal (PDCON) in response to the current detection signal (CDET). In other words, assuming that the controller 110 detects occurrence of overcurrent upon receiving a high-level current detection signal (CDET), the controller 110 outputs a high-level pull-up drive signal (PUCON) and a high-level pull-down drive signal (PDCON).

As a result, the PMOS transistor P2 is turned off and the NMOS transistor N1 is turned on, such that a low-level drive signal (DRV) is output. In this case, a current value of the drive signal (DRV) applied to the motor 200 through the node ND2 is lowered, resulting in no deterioration of the motor 200.

Second, the second case in which overcurrent is not detected in the motor driver 100 or the motor 200 will hereinafter be described in detail.

In accordance with the second case, the controller 110 outputs a low-level control signal (CON) when the current detection function is not performed. If the control signal (CON) is at a low level, the PMOS transistor P1 of the current detector 122 is turned on. Accordingly, if the PMOS transistor P2 is turned on, a current of the node ND1 is set to a specific value close to that of the node ND2.

In this case, the comparator 121 outputs a low-level current detection signal (CDET), such that the comparator 121 transmits specific information indicating the absence of overcurrent to the controller 110. Upon receiving the low-level current detection signal (CDET), the controller 110 indicates that the stall current has not been detected, so that the motor 200 begins to operate normally.

For this operation, the controller 110 may output a low-level pull-up control signal (PUCON) and a low-level pull-down control signal (PDCON) during the normal operation of the motor 200. Accordingly, the PMOS transistor P2 is turned on and the NMOS transistor N1 is turned off. As a result, a high-level drive signal (DRV) is output to the motor 200, such that the motor 200 is normally driven.

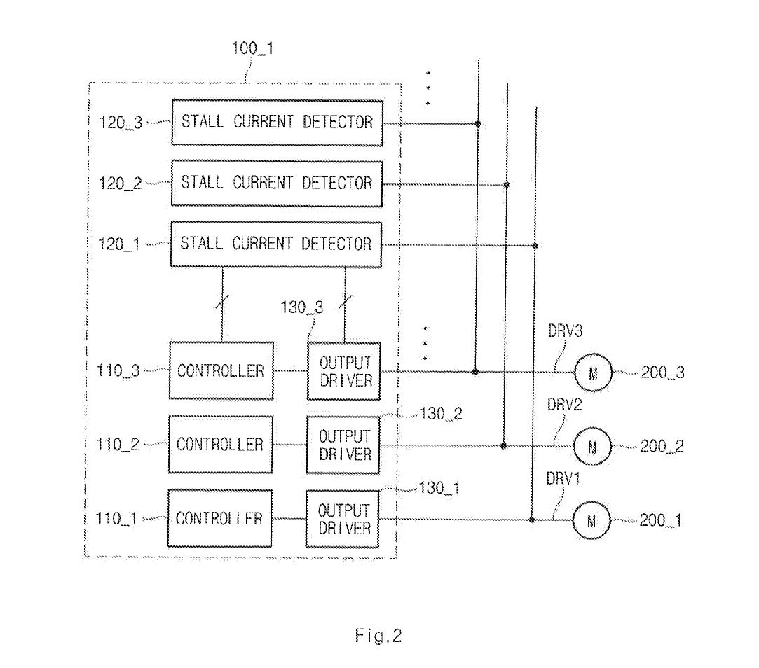

FIG. 2 is a block diagram illustrating the motor driving device for vehicles so as to control multiple motors. In more detail, FIG. 2 is a detailed block diagram illustrating the motor driving device for controlling multiple motors according to another embodiment.

Referring to FIG. 2, a multi-motor driver (100_1) includes a plurality of controllers (110_1˜110_3), a plurality of stall current detectors (120_1˜120_3), a plurality of output drivers (130_1˜130_3), and a plurality of motors (200_1˜200_3). In this case, the multi-motor driver (100_1) may include as many controllers (110_1˜110_3) as the number of motors (200_1˜200_3), as many stall current detectors (120_1˜120_3) as the number of motors (200_1˜200_3), and as many output drivers (130_1˜130_3) as the number of motors (200_1˜200_3).

Detailed descriptions of the controllers (110_1˜110_3), the stall current detectors (120_1˜120_3), and the output drivers (130_1˜130_3) are identical to those of FIG. 1 and, as such, a detailed description thereof will herein be omitted for convenience. In accordance with the embodiment, the number of motors (200_1˜200_3) is identical to the number of controllers (110_1˜110_3), the number of stall current detectors (120₁˜120₃), or the number of output drivers (130_1˜130_3). However, the scope or spirit of the embodiments are not limited thereto, the number of motors (200_1˜200_3), the number of stall current detectors (120_1˜120_3), and the number of output drivers (130_1˜130_3) may be identical to one another, and one controller (110_1) may be shared by the plurality of motors (200_1˜200_3).

The motor driving device for vehicles according to the embodiment of FIG. 2 may control the stall current detectors (120_1˜120_3) of individual channels so that the corresponding motor can be controlled. In particular, the current detector 122 of the stall current detectors (120_1˜120_3) may be independently turned on or off under the control of the controllers (110_1˜110_3), such that a stall current of the corresponding motor can be selectively detected.

As can be seen from FIG. 2, the stall current detectors (120_1˜120_3) of individual channels are controlled so that the stall current value of the multi-motor driver (100_1) may be established. In particular, under the control of the controllers (110_1˜110_3), the current selector 123 of the stall current detectors (120_1˜120_3) may be separately controlled.

For example, respective stall current detectors (120_1˜120_3) may be assigned different resistance values of the current selector 123. In this case, the stall current values of the motors (200_1˜200_3) may be detected at different levels.

The controllers (110_1˜110_3) may establish a control condition of a current maximum stall current according to a detected current detection signal (CDET), a detected temperature condition, a voltage, a predetermined motor control specification, or the like. The controllers (110_1˜110_3) may control the pull-up control signal (PUCON) and the pull-down control signal (PDCON) for controlling the output drivers (130_1˜130_3) in response to the established control condition of the maximum stall current, independently for each motor.

In particular, the controllers (110˜110_3) may control priority of stall current detection of the motors (200_1˜200_3) according to a control condition. After the stall current of the high-priority motor has been controlled, the stall current of another motor is controlled.

For example, the highest-priority indoor-air/outdoor-air motor (200_1) is first controlled through the controller (110_1), the stall current detector (120_1), and the output driver (130_1). Subsequently, the next-priority driver's seat ventilation motor (200_2) is controlled through the controller (110_2), the stall current detector (120_2), and the output driver (130_2). Thereafter, the lowest-priority driver's seat ventilation motor (200_3) is controlled through the controller (110_3), the stall current detector (120_3), and the output driver (130_3). The controllers (110˜110_3) may re-establish a control condition after the stall current of the motors (200_1˜200_3) has been controlled.

Temperature condition and control specifications established in the controllers (110_1˜110_3) are shown in the following Table 1.

TABLE 1

| Temperature Condition | Number of motor lock operations |
|---|---|
| −40° C.~75° C. | 5ea |
| −40° C.~90° C. | 4ea |
| −40° C.~105° C. | 3ea |

For example, if the temperature condition is in the range of −40° C.˜75° C., the stall current of five motors may be controlled. If the temperature condition is in the range of −40° C.˜90° C., the stall current of four motors may be controlled. In addition, if the temperature condition is in the range of −40° C.˜105° C., the stall current of three motors may be controlled.

Accordingly, the multi-motor driver (100_1) detects a maximum value of surge noise generated by external influence, such that the stall current detectors (120_1˜120_3) are independently controlled and the comparator 121 can be reduced in size.

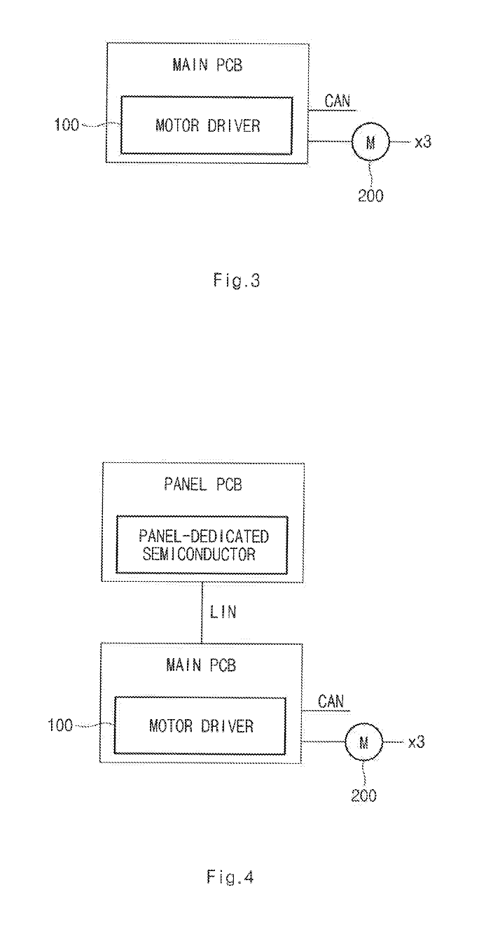

FIG. 3 is a block diagram illustrating coupling between a main Printed Circuit Board (PCB) and the motor driving device for vehicles according to the embodiments.

Referring to FIG. 3, the motor driver 100 is populated on a main PCB such that three motors 200 can be driven. The main PCB may be implemented as an air-conditioning platform controller. The main PCB may interface with an external part through Controller Area Network (CAN) communication.

In the embodiment of FIG. 3, the motor driver 100 may be incorporated into a main PCB such as Manual Temperature Control (MTC). The motor driver 100 may use a detection value of the stall current of three motors 200 as a maximum value.

FIG. 4 is a block diagram illustrating coupling between a main PCB and the motor driving device for vehicles according to the embodiments.

Referring to FIG. 4, the motor driver 100 is populated on the main PCB so as to drive three motors 200. The main PCB may be implemented as an air-conditioning platform controller. The main PCB may interface with an external part through Controller Area Network (CAN) communication.

Recently, Full Automatic Temperature Control (FATC) modules configured to maintain a comfortable environment by automatically adjusting indoor temperature according to user setting information are increasing being integrated into vehicles. In order to properly operate the air-conditioning system, manual handling of a vehicle driver or passenger who rides in the vehicle is needed. In order to solve user inconvenience caused by such manual handling of the vehicle driver or passenger, FATC devices have been developed and come into widespread use.

The motor driver 100 may be incorporated into a main PCB of the aforementioned FATC. The motor driver 100 may use a detection value of the stall current of three motors 200 as a maximum value.

The main PCB may interface with a panel PCB through a Local Interconnect Network (LINK) communication indicating serial communication. A panel-dedicated semiconductor device may be embedded in the panel PCB.

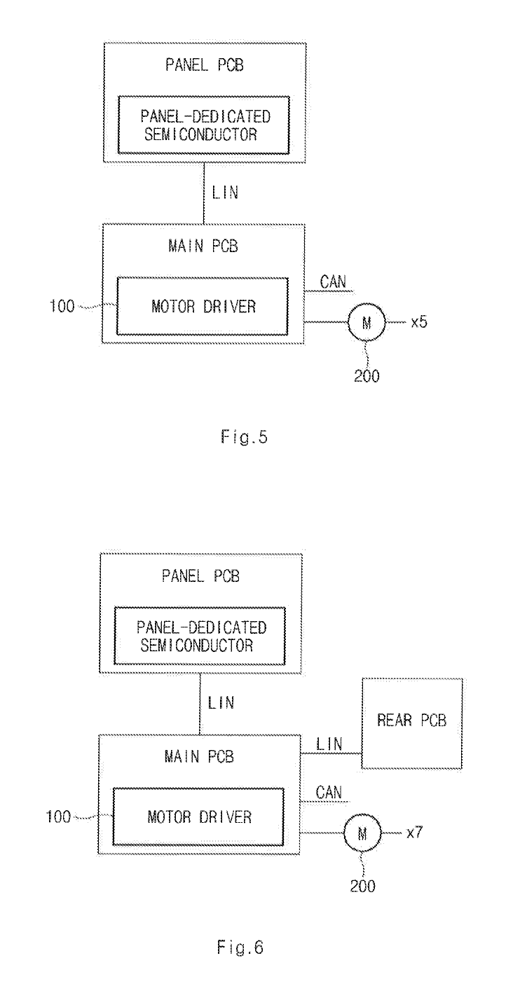

FIG. 5 is a block diagram illustrating coupling between a main PCB and the motor driving device for vehicles according to the embodiments.

Referring to FIG. 5, the motor driver 100 is populated on the main PCB so as to drive five motors 200. The main PCB may be implemented as an air-conditioning platform controller. The main PCB may interface with an external part through Controller Area Network (CAN) communication.

Dual Automatic Temperature Control (DATC) may represent a switch and controller for controlling indoor air-conditioning of the vehicle. The motor driver 100 may be incorporated into a main PCB of the DATC configured to control the air-conditioner. In the case of using the DATC specification level or higher, the motor driver 100 can control the motor 200 for each priority according to a temperature condition.

The main PCB may interface with the panel PCB through Local Interconnect Network (LIN) communication indicating serial communication. A panel-dedicated semiconductor device may be embedded in the panel PCB.

FIG. 6 is a block diagram illustrating coupling between a main PCB and the motor driving device for vehicles according to the embodiments.

Referring to FIG. 6, the motor driver 100 is populated on the main PCB so as to drive seven motors 200. The main PCB may be implemented as an air-conditioning platform controller. The main PCB may interface with an external part through Controller Area Network (CAN) communication.

“Dual Automatic Temperature Control (DATC)+Rear Right (RR)” may represent a switch and controller for controlling indoor air-conditioning of the vehicle. The motor driver 100 may be incorporated into a main PCB of the DATC+RR configured to control the air-conditioner. In the case of using the DATC+RR specification level or higher, the motor driver 100 can control the motor 200 for each priority according to a temperature condition.

The main PCB may interface with the panel PCB through LIN communication indicating serial communication. A panel-dedicated semiconductor device may be embedded in the panel PCB. In addition, the main PCB may interface with a rear PCB through LIN communication indicating serial communication.

As is apparent from the above description, the motor driving device for vehicles according to the embodiments has the following effects.

First, the motor driving device according to the embodiments prevents overcurrent from being applied to a multi-channel motor driver, resulting in prevention of the deterioration phenomenon in which overcurrent flows in chips for a long period of time such that the chips are overheated.

Second, a protection circuit of the multi-channel motor driver is minimized in size, such that chip costs can be minimized.

Third, a stall detection signal recognized by the controller can be controlled according to a user desired scheme, resulting in flexibility in motor control.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A motor driving device for a vehicle, comprising:
a stall current detector configured to output a current detection signal by detecting a stall current of a motor;
a controller configured to pre-store a control specification of the motor, and output a control signal in response to the control specification when the current detection signal is activated; and
an output driver configured to output a drive signal for controlling driving of the motor in response to the control signal.

2. The motor driving device according to claim 1, wherein the stall current detector includes:
a current detector configured to selectively activate a current detection function in response to the control signal received from the controller;
a comparator configured to compare a current of the drive signal with a current of a predetermined first node so as to output the current detection signal; and
a current selector configured to establish a reference current of the first node in response to a current selection signal received from the controller.

3. The motor driving device according to claim 2, wherein the current detector includes:
a PMOS transistor coupled between a pull-up drive element of the output driver and the first node such that the PMOS transistor is driven by the control signal.

4. The motor driving device according to claim 2, wherein the current selector includes:
a resistor coupled between the first node and a ground voltage terminal so that a resistance value of the resistor is controlled by the current selection signal.

5. The motor driving device according to claim 1, wherein the output driver includes:
a pull-up drive element driven by a pull-up control signal received from the controller when the current detection signal is activated; and
a pull-down drive element driven by a pull-down control signal.

6. The motor driving device according to claim 1, wherein the controller is configured to establish a control condition of a maximum stall current in response to at least one of the current detection signal, a temperature condition, a voltage, and the control specification.

7. The motor driving device according to claim 1, wherein the motor driving device of the vehicle is incorporated into any one of a Manual Temperature Control (MTC) Printed Circuit Board (PCB), a Full Automatic Temperature Control (FATC) Printed Circuit Board (PCB), and a Dual Automatic Temperature Control (DATC) Printed Circuit Board (PCB).

8. A motor driving device for a vehicle, comprising:
a plurality of stall current detectors configured to output a current detection signal by detecting a stall current of a plurality of motors;
a plurality of controllers configured to pre-store control specifications of the plurality of motors, and output a control signal for selectively driving the plurality of motors in response to the control specifications when the current detection signal is activated; and
a plurality of output drivers configured to output a drive signal for selectively controlling the motors in response to the control signal.

9. The motor driving device according to claim 8, wherein the plurality of controllers are configured to first control the highest-priority motor from among the plurality of motors according to a control condition of a predetermined maximum stall current, such that the plurality of motors are controlled in descending numerical order of priorities.

10. The motor driving device according to claim 8, wherein the motor driving device is configured to control the plurality of stall current detectors according to respective channels, such that stall current values of the plurality of motors are controlled separately from each other.

11. The motor driving device according to claim 8, wherein each of the stall current detectors includes:
a current detector configured to selectively activate a current detection function in response to the control signal;
a comparator configured to compare a current of the drive signal with a current of a predetermined first node so as to output the current detection signal; and
a current selector configured to establish a reference current of the first node in response to a current selection signal received from a corresponding controller.
